(19) United States
(12) Patent Application Publication
(10) Pub. No.: US 2001/0028972 A1
(43) Pub. Date: Oct. 11, 2001

(54) Apparatus for recovering water for an electrical/fuel-cell system

(76) Inventors: Rainer Autenrieth, Grossbottwar (DE); Gerhard Konrad, Ulm (DE)

Correspondence Address: EVENSON, McKEOWN, EDWARDS & LENAHAN, P.L.L.C., Suite 700, 1200 G Street, N.W., Washington, DC, 20005, US

(21) Appl. No.: 09/785,659

(22) Filed: Feb. 20, 2001

(30) Foreign Application Priority Data
Feb. 17, 2000 (DE) 100 07 244.5

(51) Int. Cl. H01M 8/04; H01M 16/00

(52) U.S. Cl. 429/26; 429/13; 429/24; 429/9

(57) ABSTRACT

In an apparatus for recovering water for an electrical/fuel-cell system in a vehicle, the cooling circuit of the vehicle radiator and/or of the air-conditioning system is coupled via a heat exchanger to at least one exhaust-gas stream of the electrical/fuel-cell system. Water precipitated due to the cooling is collected.

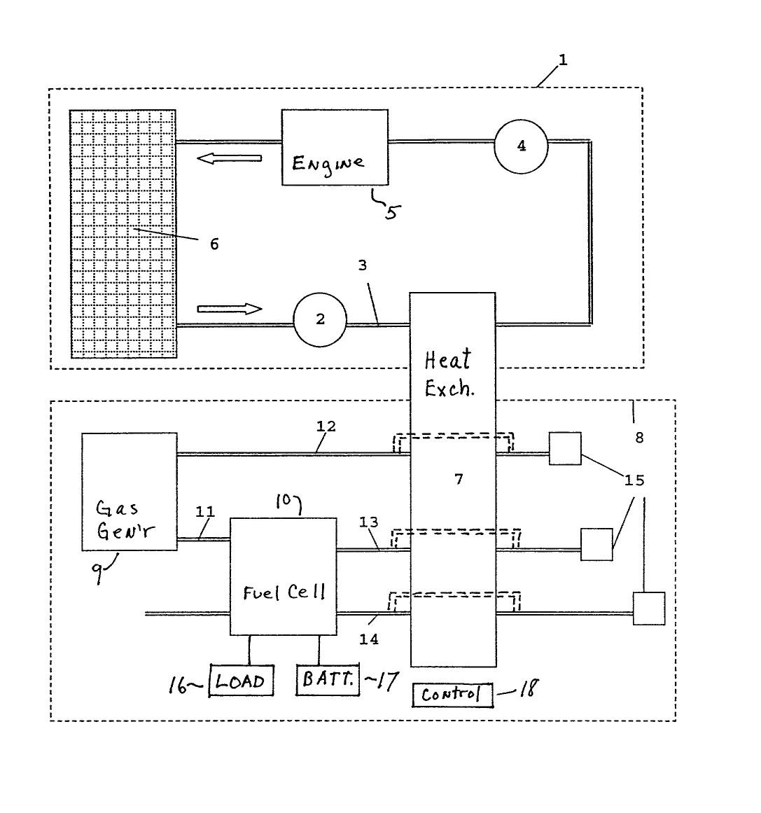

### BACKGROUND AND SUMMARY OF THE INVENTION

This application claims the priority of German patent document 100 07 244.5, filed Feb. 17, 2000, the disclosure of which is expressly incorporated by reference herein.

The invention relates to an apparatus for recovering water for an electrical/fuel-cell system in a vehicle.

All autonomous fuel-cell systems require a water supply. To produce electrical energy by means of a PEM fuel cell, it is necessary for the solid polymer electrolyte membranes to be kept in a moist atmosphere at all times. To meet this requirement, the combustion gas and the oxidizing gas are humidified with water.

With fuel-cell systems that include a gas generation system, water is likewise required for the latter. In reforming hydrocarbons for the production of hydrogen-rich synthetic gas, for example, additional water is metered to the reforming reactor.

In addition, water is also used to cool the fuel cell.

To avoid the need for an on-board water tank and filling it on a regular basis, U.S. Pat. No. 5,780,179 discloses the recovery of water from the exhaust gases of the fuel-cell system, using condensate traps. The disadvantage with this method, however, is that the quantity of water obtained is relatively small, because of the high temperature of the exhaust gases of the fuel-cell system, and is not sufficient to keep the electrical/fuel-cell system supplied with water. With this apparatus, it is thus still necessary to top up a water tank on a regular basis.

It is therefore an object of the present invention to provide an apparatus which can provide a sufficient quantity of water for the operation of the fuel-cell system, on board a motor vehicle.

This and other objects and advantages are achieved by the apparatus according to the invention, in which the cooling circuit of the vehicle radiator and/or the cooling circuit of the air-conditioning system is coupled via a heat exchanger to at least one exhaust-gas stream of the electrical/fuel-cell system. This provides the capacity for cooling it to the very low temperature required for water to condense out of the stream of exhaust gas. Suitable streams of exhaust gas from which water can be recovered are, in particular, the anode and cathode exhaust gas of the fuel cell, and the exhaust gas of the gas generation system. One or more of these exhaust-gas streams can be coupled to the cooling circuit of the vehicle radiator, as desired.

The high cooling capacity and the low temperature of the vehicle radiator ensure that the amount of water recovered is sufficient for the operation of the fuel-cell system (positive water balance). It is therefore possible to dispense with an onboard water tank.

Since the vehicle radiator, its cooling circuit or the cooling circuit of the air-conditioning system are present in the vehicle anyway, their use according to the invention does not give rise to any further costs. In addition, only a very small amount of additional installation space is required.

The apparatus according to the invention can be employed universally in mobile systems, especially in motor vehicles, railway systems or aircraft. It is particularly suitable for PEM fuel-cell systems.

The waste heat from the electrical fuel-cell system fed to the cooling circuit of the vehicle radiator can advantageously be used to preheat the engine or for auxiliary heating. This has additional advantages for the user of the vehicle in terms of comfort.

The condensed water is advantageously separated from the exhaust gases by means of a condensate trap, arranged downstream of the heat exchanger. In a preferred embodiment, a pump is arranged in the cooling circuit of the vehicle radiator or of the air-conditioning system to ensure adequate circulation of the coolant.

By the very nature of the system, the water yield of the apparatus according to the invention depends very significantly on the temperature of the vehicle radiator. It can therefore be advantageous to couple the cooling circuit to one or more exhaust-gas streams of the electrical/fuel-cell system as a function of the temperature of the vehicle radiator. For example, the apparatus can be designed in such a way that the exhaust-gas streams are connected into the heat exchanger circuit only when the vehicle radiator is below a certain predetermined temperature.

In another embodiment, the electrical/fuel-cell system is coupled to a battery. In vehicle operating phases in which the radiator is at a high temperature, the power requirements of the vehicle can be covered by the battery. In vehicle operating phases in which the radiator is at a relatively low temperature, especially when the vehicle is stationary and the radiator has cooled down, the electrical/fuel-cell system is used for power generation.

Other objects, advantages and novel features of the present invention will become apparent from the following detailed description of the invention when considered in conjunction with the accompanying drawings.

### BRIEF DESCRIPTION OF THE DRAWINGS

The single FIGURE of the drawing is a schematic diagram which shows the fundamental construction of the electrical/fuel-cell system in a vehicle.

### DETAILED DESCRIPTION OF THE DRAWINGS

The FIGURE shows an embodiment of the apparatus according to the invention in a motor vehicle with an internal combustion engine 5. To allow the internal combustion engine 5 to be cooled, it is connected to a conventional cooling circuit 1, in which a pump 2 passes the coolant within the line 3 through the vehicle blower 4, the engine 5 and the vehicle radiator 6. According to the invention, the cooling circuit furthermore contains a heat exchanger 7, the operation of which will be explained in greater detail below.

The electrical/fuel-cell system 8 comprises a gas generation system 9 for generating hydrogen-rich synthetic gas and a fuel cell 10. The fuel cell 10 is in turn connected to supply electric energy to a vehicle load 16 and/or to a vehicle battery 17.

The gas generation system 9 supplies the fuel cell 10 with combustion gas via a feed line 11. Reference numeral 12 denotes the exhaust line of the gas generation system 9. Reference numerals 13 and 14 denote the exhaust lines (anode exhaust gas 13, cathode exhaust gas 14) of the fuel cell 10.

To enable water to be recovered, the exhaust lines 12, 13, 14 are fed to the heat exchanger 7, which is coupled to the cooling circuit 1 of the motor-vehicle radiator 1. As depicted schematically by the broken lines in the figure, the exhaust lines 12-14 are alternatively coupled in heat transfer communication with the heat exchanger, or bypass it, under the control of a control unit 18, based on the temperature of the vehicle radiator 6.

Arranged downstream of the heat exchanger 7 in each exhaust line is a condensate trap 15. In this, the water that condenses out of the exhaust gases is removed. The water obtained there can be used to cover the water supply requirements of the electrical/fuel-cell system 8.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. Apparatus for recovering water for an electrical/fuel-cell system in a vehicle, wherein a cooling circuit of one of a vehicle radiator and a vehicle air-conditioning system is coupled via a heat exchanger to at least one exhaust-gas stream of the electrical/fuel-cell system.

2. The apparatus according to claim 1, wherein the exhaust-gas stream of the electrical/fuel-cell system comprises at least one of an anode exhaust-gas stream, and a cathode exhaust-gas stream and an exhaust-gas stream from a gas generation system.

3. The apparatus according to claim 1, wherein a condensate trap is arranged downstream of the heat exchanger in the exhaust-gas stream or streams.

4. The apparatus according to claim 1, wherein the cooling circuit contains a pump that allows circulation of the coolant of the cooling circuit.

5. The apparatus according to claim 1, wherein the cooling circuit can be coupled to at least one exhaust-gas stream of the electrical/fuel-cell system as a function of temperature of the vehicle radiator.

6. The apparatus according to claim 5, wherein the electrical/fuel-cell system is coupled to a battery.

7. A method of operating a device for recovering water for an electrical/fuel cell system in a vehicle having a fuel cell coupled to an electric energy accumulator, and a cooling circuit for at least one of a vehicle radiator and a vehicle air conditioning system, comprising:
cooling at least one exhaust gas stream from said fuel cell in a heat exchanger that is coupled to transfer heat to said cooling circuit;
collecting water precipitated from cooled gases in said exhaust gas stream;
operating said fuel cell when a temperature in said cooling circuit is below a preset value; and
supplying power from said electric energy accumulator when the temperature in the cooling circuit exceeds said preset value.

8. The method according to claim 7, wherein heat supplied to the cooling circuit of the vehicle radiator from the at least one exhaust-gas stream is used for one of preheating an engine and for auxiliary heating.

9. Apparatus for recovering water for an electrical/fuel cell system having at least one output exhaust gas stream, in a vehicle having a cooling circuit for one of a vehicle radiator and a vehicle air conditioner, said apparatus comprising:
a heat exchanger connected between said at least one of said at least one exhaust gas stream and cooling circuit, for cooling said at least one exhaust gas stream by transferring heat therefrom to said cooling circuit; and
a condensate recovery device for recovering water precipitated in said cooled exhaust gas stream.

10. The apparatus according to claim 9, wherein the exhaust-gas stream of the electrical/fuel-cell system comprises at least one of an anode exhaust-gas stream, and a cathode exhaust-gas stream and an exhaust-gas stream from a gas generation system.

11. The apparatus according to claim 9, wherein said at least one exhaust gas stream is interruptibly coupled in heat transfer communication with said cooling circuit, as a function of a temperature of the vehicle radiator.
